(19) United States
(12) Patent Application Publication
(10) Pub. No.: US 2008/0175879 A1
(43) Pub. Date: Jul. 24, 2008

(54) Table cloths or table covers invisible to and capable of repelling insects and animals

(76) Inventor: Terry M. Feinberg, St. James, NY (US)

Correspondence Address: PANAGIOTA BETTY TUFARIELLO, ESQ.;THE LAW OFFICES OF P.B TUFARIELLO, P.C., INTELLECTUALLAW, 25 Little Harbor Rd., Mt. Sinai, NY, 11766, US

(21) Appl. No.: 11/657,440

(22) Filed: Jan. 23, 2007

(51) Int. Cl. A01N 25/00; A01N 65/00; A01P 17/00

(52) U.S. Cl. 424/405; 424/736

(57) ABSTRACT

There is provided a covering for laying over the top of any eating, drinking or sleeping surface, or a table cloth or a table cover substantially less visible, if not invisible to, and capable of, repelling insects and animals. The covering is opaque and bears a color that is outside the vision spectrum of animals and insects. It comprises a synthetic resin, a non-toxic dye and all natural insect and animal repellent mixture. The all natural insect and animal repellent mixture further comprises peppermint oil, lemon oil, citronella oil, rosemary oil, clove oil and geranium oil. In the preferred embodiment the all natural, insect and animal repellent mixture comprises 15% peppermint oil, 10% lemon oil, 4% citronella oil, 5% rosemary oil, 3% clove oil and 3% geranium oil.

### BACKGROUND OF THE INVENTION

1. Field of Invention

The present invention relates to coverings especially designed to cover the tops of tables, especially during a meal, for the protection of food, drinks and diners from insects and pests. More particularly, it relates to new and improved plastic table covers and table cloths which are not only capable of repelling small animals and insects away from food, drinks and diners in a safe manner, but are also substantially less visible, if not invisible, and attractant thereto.

2. Description of the Prior Art

The unwelcome presence of insects at picnics and outdoor patios has been endured for generations and accepted as an unavoidable concomitant of outdoor dining. So much so in fact, that the general consensus is that outdoor dining without insects is really not outdoor dining. Media commercials have glorified it, and countless are the advertising references to comical depictions of insects that are humanized and who regularly torture outdoor-dining humans, either directly through stings and bites, or indirectly by contaminating the humans' food by landing on it or by stealing it.

Notwithstanding their glorification in the media, insects are in fact greatly annoying. For the majority of picnickers and outdoor diners all insects, both stinging and non-stinging, are nothing but a source of aggravation and unpleasantness. As for those outdoor diners who can have serious allergic reactions to the sting of, for example a bee or a wasp, the presence of insects can have very serious and fatal consequences.

Equally as annoying, can be such scavengers as squirrels, raccoons, mice, hungry wild dogs, abandoned cats and other small animals. Just like the insects, such scavengers will be attracted to the food laid out for eating, whether on a beautifully laid out table on a well appointed patio, or on a colorful blanket on the beach; particularly when the diners have distanced themselves therefrom.

Both the insects and the scavenging animals first detect the food with either their sense of sight or smell, or both, which in turn allows them to recognize the food to be dined upon, as a viable source of nourishment. Then, via their sense of smell coupled with their vision, they will gravitate to the food, whereupon they will attack it, devour it and create a mess in the process. Alternatively they will alight on the food, and contaminate it with germs and microbes, which in turn can lead to illness to the humans who consume the now contaminated food. Or worse still, if they cannot get to the food, they alight on the humans surrounding the food or being in the vicinity of the food, to sting them or bite them in the process.

To prevent the alighting of insects on food, or the theft of food by scavenging animals in outdoor venues, human diners are constrained to stay close by. However, while their presence might scare off small scavengers, it really does nothing to prevent insects from landing on the food; or on them for that matter. Thus, they are forced to resort to such commercially available devices as citronella oil lanterns, citronella candles, citronella smoke sticks or insect electrocuting devices.

Insect electrocuting devices comprise a light located in the center of the devices and electrified wires. The light attracts the insects. When the insects move toward the light, they must pass through the electrified wires, which in turn electrocute them, or “zap” them.

These units however have drawbacks. First of all, they make a very annoying, zapping noise, every time an insect flies into them. It is not unusual for a quiet summer night to be continuously disturbed by the characteristic zapping sound made by the sudden and untimely electrocution of an insect that has wandered near the units' electrified wires. Further, if the insects do not fly into the unit they will not be killed. More importantly, however, these units will only kill insects that are attracted to their light, which means that mosquitoes, the perennial summer pest, are immune to the bug zapper. In 1996, a University of Delaware study found that only 0.22 percent of insects killed by zappers in several locations were mosquitoes or biting gnats. On the other hand, 48 percent were, in fact, harmless and even beneficial aquatic insects from nearby water sources. Killing this many beneficial insects, the researchers said, could disrupt the local ecosystem. Finally, these units cannot operate without electricity. These units are not portable and highly impractical, since their use is totally dependent on electricity and is strictly limited to areas where electricity is available. You cannot carry a bug zapper into the middle of the forest.

On the other hand, the smell of oil of citronella does in fact repel blood-feeding mosquitoes, ticks, and fleas. The oil is extracted from Cymbopogon nardus and Cymbopogon winterianus grasses. Thus, citronella oil lanterns, citronella candles and other citronella products such as smoke sticks and coils, produce odors that keep most insects away. However the odor can be quite strong, so they need to be lit well in advance of a gathering. Otherwise their strong odor will interfere with the dining experience, and for many diners who can be very sensitive to the citronella odor, may even ruin it.

In view of the foregoing, the relevant and material prior art has tried to address the problem of ever present insects and scavengers in outdoor dining venues in a number of other ways. For example:
Briggs, U.S. Pat. No. 3,744,500 attempts to solve said problem with a foldable, portable, light weight, screen enclosure for picnic tables, which is adjustable to fit all types of tables irrespective of length and width. The screen enclosure comprises an enclosure framework having corner uprights with horizontally extending arms at their lower ends slidably receivable in horizontal tubular sockets in respective attachment members releasably clamped to the table corners. Horizontal members interconnecting the upper ends of the uprights are hinged at their respective ends and midpoints, permitting the framework structure to fold into a compact bundle of parallel frame elements.
Shaw, U.S. Pat. No. 5,060,580 attempts to solve said problem with a table that is structured to hold food stuffs safe from insect and other small animal intrusion, while simultaneously providing for easy access to the food stuffs, while also providing a surface that can be used as a place setting for eating of the food stuffs. The table comprises a table member that includes an internal storage area for holding articles therein, at least one movably mounted screened cover for enclosing the internal storage area, and a plurality of legs for holding the table member at a preselected height. The table further includes means for adjusting the length of the legs, a planar cover for the table for covering at least a portion of the internal storage area and thereby provide an eating surface, leg detachment means for permitting the legs to be selectively detached from the table member in order to facilitate portability of the table and table member fold means for permitting the table member to be foldable into a compact unit that may be readily carried in a standard automobile trunk;
Johnson, U.S. Pat. No. 5,832,943 attempts to solve said problem with a semi-cylindrical cover for a table, especially for an outdoor picnic table, that may be placed over food and drink that is left on the table, for protecting the food and liquid refreshment while a family or other group temporarily leaves the table unattended. The cover will protect the food and drink from the heat of the sun, wind, rain, falling leaves, bird droppings, insects or other pests. It includes a rectangular main portion that is made of a flexible waterproof material. The main portion is supported over the table by rigid, semicircular ribs which maintain the main portion in a curved shape. Semicircular end portions are attached to the opposite ends of the main portion for protection at the ends of the picnic table. After positioning, the ends of clamps are passed through pairs of holes provided in the cover to clamp each side portion of the cover between a clamping member and a side of the picnic table;
Willet, U.S. Pat. No. 6,014,935 attempts to solve said problem with an all weather outdoor table cover which has a tablecloth for placement on a table, straps attached at the tablecloth perimeter to provide for securing to the table top, and a protective cover attached to a portion of the tablecloth perimeter, which is constructed of a pliable material so that it may be folded for storage when not in use. A hem is formed in the perimeter of the protective cover. The hem has a draw cord contained therein which is accessible through two openings. When it is desired to cover the table and its contents, the protective cover may be puled over the table top and secured under it by pulling on the draw cords to put the protective cover under the table top. This will protect the tablecloth and the contents from weather, pests and the like. Storage pockets may also be attached to the perimeter of the tablecloth; and
Rivers, United States Patent Application Publication No. US 2003/0106471 A1 attempts to solve said problem with a portable elevated picnic table cover, which includes an enclosure dimensioned for being positioned atop a picnic table. The enclosure is constructed of a transparent material. The enclosure has a closed top, an open bottom, and a peripheral side wall therebetween. The open bottom is positioned over the picnic table. The peripheral side wall has at least one access opening therethrough. The access opening has a corresponding removable flap coupled thereto. A pair of support brackets is positioned within the enclosure for supporting the enclosure in a raised orientation.

The devices set forth herein above successfully keep away insects and scavenging animals or pests by erecting a physical barrier around a table in an outdoor venue, when the diners have distanced themselves there from, and/or the table is simply used as a storage shelf for the food and drink laid thereon. However, said devices fail miserably at keeping and preventing pests of all kinds from alighting thereon, once the outdoor diners or users remove the patented barriers therefrom for the purpose of accessing the food and drink and socializing around said table. So, once the devices are removed from around the table, or food is now open and accessible, not only will diners approach but insects will flock too, attracted by the smells and visions, to spread annoyance and discomfort.

In addition, the devices set forth herein above are bulky, heavy and difficult to travel with. Most all of them require some sort of assembly and time to be assembled and secured on tables; time taken away from entertainment and other activities normally associated with picnics and outdoor gatherings. As a result, picnickers will be discouraged from using them in outdoor dining venues such as parks and beaches. As for hunters, who are already burdened with the usual hunting paraphernalia, they would not even dream of bringing these devices with them for the purpose of keeping insects and pests away from their stuff.

Mahan, U.S. Pat. No. 5,107,620 attempts to address the drawbacks of all of the devices set forth herein above with an electrified table cloth, used to prevent crawling insects from gaining access to the consumer's food or drink in outdoor dining venues. Such electrified table cloth comprises a cloth formed of electrically insulated material which has at least one pair of parallel electrically conductive strips secured to the edge or border of the cloth to completely encircle the cloth, and which are connected to a low voltage DC battery also secured to the cloth. The strips of electrical conductive material are spaced apart sufficiently to normally prevent completion of a circuit across the strips and for completion of a circuit across said strips through an insect's body as the insect attempts to traverse the strips when crawling across the edge of the cloth. The electrical current passing through the insect's body is sufficient to produce a sensation which will discourage further travel across the edge of the cloth. A consumer who may come into contact with the strips will usually not feel the current and, even if the consumer is wet, the current will produce only a slight tingling sensation. The electrical apparatus may also be provided in kit form to be installed on table cloths by consumer.

The requirement of a battery on the Mahan device, only replaces one set of bulkiness problems with another set of bulkiness problems. For example, if the battery is placed at the outer perimeter of the tablecloth, it will shift the tablecloth's center of gravity making it almost impossible to keep it on the table. Alternatively, if the battery is placed more towards the center of the tablecloth, it will create a bulky section on the table itself generating all kinds of instability problems in connection with the food, drink and utensils thereon.

In addition, Mahan only addresses the problem of insects who attempt to gain access to the outdoor diners' food and drink by crawling from the outer perimeter or edge of the tablecloth inwards, towards the center part of the tablecloth, where the food and drink are invariably placed. It does nothing to repel or prevent insects from getting altogether close to either the tablecloth or the dining area. Furthermore, it does nothing to prevent flying insects from landing on the food or drink from the top, without necessarily walking and crossing over the outer perimeter, the outer edge of the tablecloth and it does nothing to prevent the insects from crawling or alighting on the diners themselves. Finally, the Maher device will fail to work altogether, if the low voltage DC battery is spent, or if the strips of electrical conductive material somehow become broken and are no longer capable of closing the circuit to deliver current to an insect's body.

Accordingly, there really is a need for an insect and pest repelling device that is quick and easy to use, light to pack, and light to carry, and will work to repel insects and pests both from the food and diners themselves in the outdoor venue picnic table or blanket picnic spot, whether in a park, on the beach, or on the back yard patio, on the boat, or during a hunting trip; whether the diners are around the picnic table or picnic area or not. Furthermore, there is a need for an insect and pest repelling device that will work to repel insects and pests from the outdoor venue picnic table or beach blanket picnic spot, whether in a park, on the beach, or on the back yard patio, in a manner that does not upset the ecosystem, does not need electricity, does not require the use of flames or candles, is pleasant to the senses, and most importantly does not interfere with and enhances the outdoor dining experience.

### OBJECTS OF THE INVENTION

IT IS THEREFORE AN OBJECT of the present invention to provide a table cloth which is substantially less visible, if not invisible, to both animals and insects.

IT IS ANOTHER OBJECT of the present invention to provide a table cloth which effectively repels both animals and insects, both from the food and drink placed on the tablecloth, and the diners themselves.

IT IS YET ANOTHER OBJECT of the present invention to repel both insects and animals from outdoor dining venues, irrespective of where such dining venues are located, with coverings for use on the tops of tables, especially during dining, that contain all natural insect and animal repellents and are substantially less visible, if not invisible, to said insects and animals.

IT IS STILL ANOTHER OBJECT of the present invention to provide a tablecloth which effectively keeps away both animals and insects by being substantially less visible to them, while simultaneously repelling them through all natural repellents.

IT IS A FURTHER OBJECT of the present invention to provide a substantially less visible repellent-containing tablecloth that poses no health risks to either human, animal or the ecosystem.

IT IS YET A FURTHER OBJECT of the present invention to provide a repellent-containing tablecloth that poses no environmental risks whatsoever.

IT IS STILL A FURTHER OBJECT of the present invention to provide a repellent-bearing tablecloth, whose repellent cannot be removed or wiped off

IT IS ANOTHER OBJECT of the present invention to provide a novel pest repellent composition and dye which can be incorporated into a tablecloth to render it capable of repelling insects and other animals both through the repellent and through the fact that the dye renders the tablecloth substantially less visible, if not invisible to both insects and animals.

These objects, as well as other objects and advantages will become more apparent in the description that is set forth herein below, particularly when read in conjunction with the accompanying drawings.

### SUMMARY OF THE INVENTION

According to the present invention there is provided a covering for laying over the top of any eating, drinking or sleeping surface, or a table cloth, or a table cover, which is substantially less visible, if not invisible to, and capable of, repelling insects and animals. The covering is opaque and bears a color that is outside the vision spectrum of animals and insects. It comprises a synthetic resin, a non-toxic dye and all natural insect and animal repellent mixture. The all natural insect and animal repellent mixture further comprises peppermint oil, lemon oil, citronella oil, rosemary oil, clove oil and geranium oil. In the preferred embodiment the non-toxic dye is red and the all natural, insect and animal repellent mixture comprises 15% peppermint oil, 10% lemon oil, 4% citronella oil, 5% rosemary oil, 3% clove oil and 3% geranium oil.

### BRIEF DESCRIPTION OF THE DRAWINGS

While the specification concludes with claims which particularly point out and distinctly claim the present invention, it is believed that the present invention will be better understood from the following detailed description taken in conjunction with the accompanying drawings in which like numerals represent identical elements and wherein:

FIG. 1 is a perspective view of the animal and insect repellent, invisible tablecloth of the present invention, as it is removed from its packaging, for use to lay out food and drink, formed of a synthetic resin which contains therein a composition having insect and animal repellent properties and a dye rendering the pest repellent tablecloth visible to the human eye but substantially less visible to the eyes of insects, animals, or both.

FIG. 2 is a perspective view of the pest-repellent, pest invisible table cloth of FIG. 1;

FIG. 3 is a perspective view of one method of manufacture of the pest repellent sheets that will give rise to the table cloths of the present invention; and

FIG. 4 is a perspective view of the inventive pest repellent, pest invisible table cloths in actual use on a table.

### DETAILED DESCRIPTION OF THE INVENTION

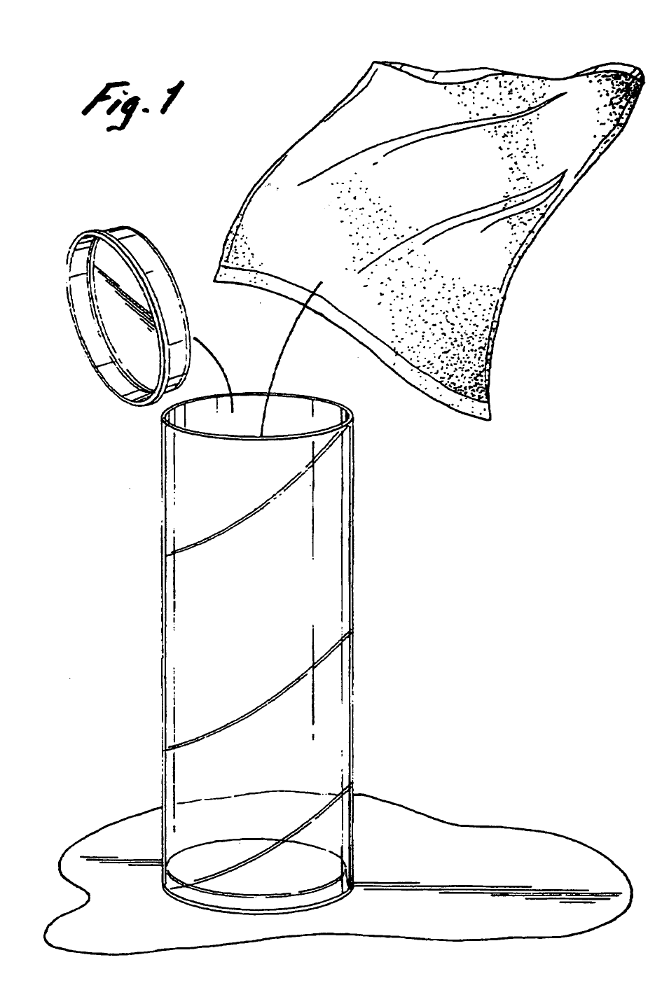

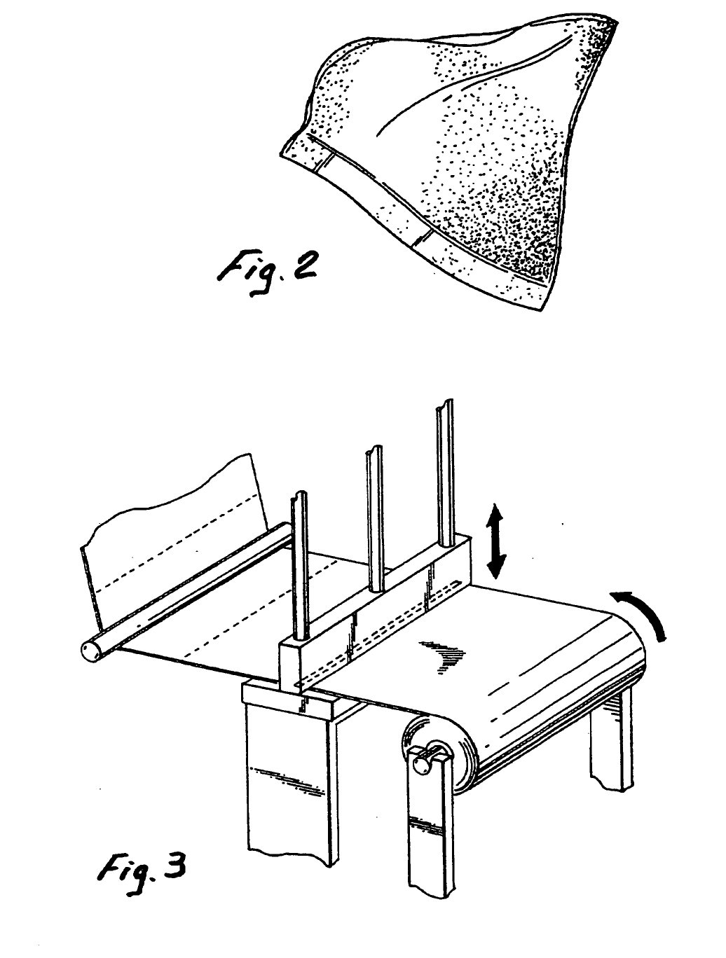

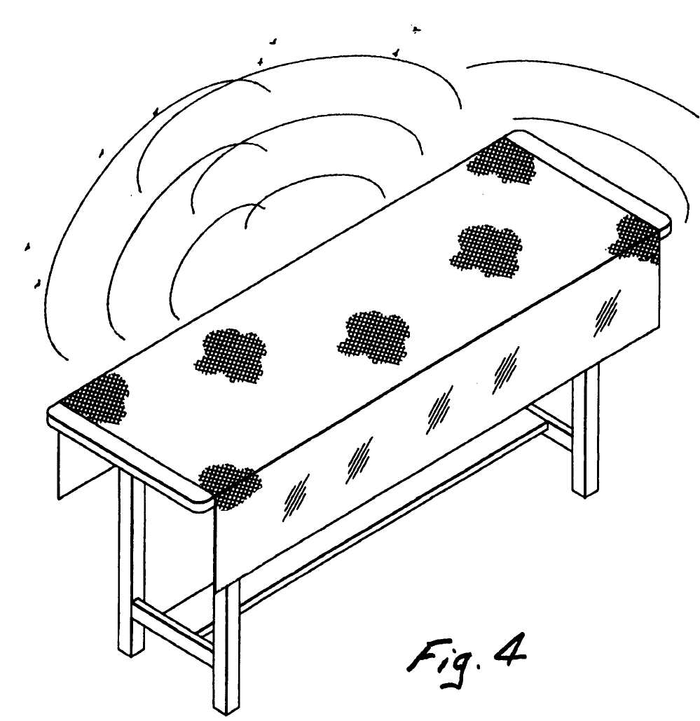

Referring more specifically to the drawings, FIGS. 1 through 4 generally depict the inventive table cloth or table cover (hereinafter collectively “table cloth”). The inventive table cloth is designed to replace whatever table cloths and insect repellent devices that are currently available for use in open air dining venues such as backyards, patios, parks, beaches, hunting grounds, camping grounds and others. It has been engineered not only to be suitable for covering the top of a table, especially during a meal, but for covering the top of any eating and drinking surface in outdoor dining venues. Furthermore, once in place, as shown in FIG. 4, it is designed to be substantially less visible to both animals and insects while simultaneously repelling them.

The inventive table cloth comprises a plastic resin and an FDA approved dye, suitable for human ingestion. Tablecloths according to the present invention are made by first mixing the virgin plastic or recycled plastic resin which is in pelletized form and the dye in proportions that will result in a substantially opaque, colored tablecloth, whose color is outside the vision spectrum of animals and insects. Thereafter, the resulting mixture is formed into flexible sheets either by calendering, or by extrusion, preferably followed by drawing in one or more directions at right angles to each other.

The plastic resin pellets may be made from any film-forming polymer, including polyvinyl chloride and copolymers thereof, e.g. with vinylidine chloride; polypropylene, polysulphones and poly-4-methyl-pentene In the preferred embodiment a low density polythene is used on account of its inexpensiveness, and wide use in the manufacture of plastics. Or alternatively virgin plastic resin made from up to 80% recycled industrial scrap with a blend of strength enhancers can be used to form the table cloth.

The dye used to form the table cloths comprises a low density, polyethylene concentrate in pellet form having a color that is outside the spectrum of insects' and animals' vision and approved by the FDA for human consumption. In the preferred embodiment, the dye is a red dye that has been approved by FDA for human consumption.

The inventive table cloth further comprises an insect and animal all natural repellant mixture. It comprises a mixture of all natural ingredients that are registered for use either as food additives or as perfume ingredients. They are considered non-toxic and exempted from registration with the EPA. Even more importantly, they are all approved by the FDA. They comprise peppermint oil, lemon oil, citronella oil, rosemary oil, clove oil, and geranium oil. In the preferred embodiment of the repellant mixture the percent concentration of each of the foregoing natural components of the repellant mixture is as follows: 15% peppermint oil, 10% lemon oil, 5% rosemary oil, 4% citronella oil, 3% clove oil and 3% geranium oil. Notwithstanding the fact that the repellant mixture comprises all natural materials, it is capable of repelling pests, including cockroaches, rats, mice, cats, dogs, raccoons and many others.

Once the repellant mixture is assembled and mixed, it is pelletized in preparation for the next step in the process of producing the inventive tablecloth. It is pelletized with inert ingredients consisting of plastic resin, apple pumice and mineral oil. In the preferred embodiment it is pelletized in such a fashion that 40% of each of the pellets comprises the repellant mixture and 60% of each of the pellets comprises the inert ingredients. The pelletized repellant mixture, the plastic resin pellets and the dye are mixed in a proportion that when the tablecloth is extruded and formed, it is opaque, has a color that is outside the vision spectrum of animals and insects, as for example it is red, and emits a very pleasant and mild characteristic aroma of the active ingredients of the insect repellent mixture. The dimensions of the tablecloth, i.e. length, width and thickness, will vary on a case by case basis and will depend on the various applications of the tablecloth.

It is clear then from all of the above, that incorporating the dye into the pelletized plastic resin, and more particularly a red dye, renders the tablecloth substantially less visible and indiscernible to pests, both insects and animal. Furthermore, incorporating the repellant mixture further enhances the table cloth indiscernibility qualities by rendering it into an pest repelling device.

It is also clear from all of the above that it would be rather counter intuitive to use a dye, and particularly a red dye in the formation of the inventive table cloth because the prior art actually states that the color red is actually attractive to insects and animals. Yet the red dye being used, in the concentrations that it is being used in, results in a red opaque table cloth that is invisible, if not substantially less visible and indiscernible to the pests.

Finally, it is clear from the above that the inventive table cloth is effectively indiscernible to both animals and insects; effectively repels both animals and insects with repellents that are all natural; and provides a repellent-containing table cloth that poses no health risks to either human or domestic animal or risks to the environment. So much so, in fact, that the table cloths can also be used to lay under camping tents and sleeping bags, for tying up and storage of food stuffs, from trees on hunting trips, and anywhere else where insects need to be repelled from either food, or humans, or both.

While particular embodiments of the invention have been illustrated and described in detail herein, they are provided by way of illustration only and should not be construed to limit the invention. Those skilled in the art will readily recognize that various modifications and changes may be made to the present invention without departing from the spirit and intent of the present invention, as defined by the scope of the following claims.

What is claimed is:

1. A tablecloth, substantially less visible, if not invisible to, and capable of, repelling insects and animals.

2. The tablecloth as claimed in claim 1, wherein said tablecloth is opaque and bears a color that is outside the vision spectrum of animals and insects.

3. The tablecloth as claimed in claim 2, wherein the color that is outside the vision spectrum of animals and insects is red.

4. The colored, opaque tablecloth as claimed in claim 2, comprising a synthetic resin and a non-toxic dye.

5. The red, opaque tablecloth as claimed in claim 3, comprising a synthetic resin and a non-toxic red dye.

6. The colored, opaque tablecloth as claimed in claim 4, wherein the non-toxic dye is FDA approved.

7. The red, opaque tablecloth as claimed in claim 5, wherein the non-toxic red dye is FDA approved.

8. The colored, opaque tablecloth as claimed in claim 2, comprising an all natural insect and animal repellent mixture.

9. The red, opaque tablecloth as claimed in claim 3, comprising an all natural insect and animal repellent mixture.

10. The colored, opaque tablecloth as claimed in claim 4, comprising an all natural insect and animal repellent mixture.

11. The red, opaque tablecloth as claimed in claim 5, comprising an all natural insect and animal repellent mixture.

12. The colored, opaque tablecloth as claimed in claim 6, comprising an all natural insect and animal repellent mixture.

13. The red, opaque tablecloth as claimed in claim 7, comprising an all natural insect and animal repellent mixture.

14. The colored, opaque tablecloth as claimed in claim 8, wherein said all natural insect and animal repellent mixture further comprises peppermint oil, lemon oil, citronella oil, rosemary oil, clove oil and geranium oil.

15. The colored, opaque tablecloth as claimed in claim 8, wherein said all natural insect and animal repellent mixture further comprises 15% peppermint oil, 10% lemon oil, 4% citronella oil, 5% rosemary oil, 3% clove oil and 3% geranium oil.

16. The red, opaque tablecloth as claimed in claim 9, wherein said all natural insect and animal repellent mixture further comprises peppermint oil, lemon oil, citronella oil, rosemary oil, clove oil and geranium oil.

17. The red, opaque tablecloth as claimed in claim 9, wherein said all natural insect and animal repellent mixture further comprises 15% peppermint oil, 10% lemon oil, 4% citronella oil, 5% rosemary oil, 3% clove oil and 3% geranium oil.

18. The colored, opaque tablecloth as claimed in claim 10, wherein said all natural insect and animal repellent mixture further comprises peppermint oil, lemon oil, citronella oil, rosemary oil, clove oil and geranium oil.

19. The colored, opaque tablecloth as claimed in claim 10, wherein said all natural insect and animal repellent mixture further comprises 15% peppermint oil, 10% lemon oil, 4% citronella oil, 5% rosemary oil, 3% clove oil and 3% geranium oil.

20. The red, opaque tablecloth as claimed in claim 11, wherein said all natural insect and animal repellent mixture further comprises peppermint oil, lemon oil, citronella oil, rosemary oil, clove oil and geranium oil.

21. The red, opaque tablecloth as claimed in claim 11, wherein said all natural insect and animal repellent mixture further comprises 15% peppermint oil, 10% lemon oil, 4% citronella oil, 5% rosemary oil, 3% clove oil and 3% geranium oil.

22. The colored, opaque tablecloth as claimed in claim 12, wherein said all natural insect and animal repellent mixture further comprises peppermint oil, lemon oil, citronella oil, rosemary oil, clove oil and geranium oil.

23. The colored, opaque tablecloth as claimed in claim 12, wherein said all natural insect and animal repellent mixture further comprises 15% peppermint oil, 10% lemon oil, 4% citronella oil, 5% rosemary oil, 3% clove oil and 3% geranium oil.

24. The red, opaque tablecloth as claimed in claim 13, wherein said all natural insect and animal repellent mixture further comprises peppermint oil, lemon oil, citronella oil, rosemary oil, clove oil and geranium oil.

25. The red, opaque tablecloth as claimed in claim 13, wherein said all natural insect and animal repellent mixture further comprises 15% peppermint oil, 10% lemon oil, 4% citronella oil, 5% rosemary oil, 3% clove oil and 3% geranium oil.

26. A covering for laying over the top of any eating, drinking or sleeping surface comprising a plastic resin, a dye and an all natural insect and animal repellent mixture whereby said covering is opaque, has a color that is substantially less visible, if not invisible to, and repels both animals and insects.

27. The colored, opaque tablecloth as claimed in claim 26, wherein the dye is non-toxic dye and FDA approved.

28. The colored, opaque tablecloth as claimed in claim 27, wherein the non-toxic, FDA approved dye is red.

29. The covering as claimed in claim 26, wherein said all natural insect and animal repellent mixture further comprises peppermint oil, lemon oil, citronella oil, rosemary oil, clove oil and geranium oil.

30. The covering as claimed in claim 26, wherein said all natural insect and animal repellent mixture further comprises 15% peppermint oil, 10% lemon oil, 4% citronella oil, 5% rosemary oil, 3% clove oil and 3% geranium oil.

31. The covering as claimed in claim 27, wherein said all natural insect and animal repellent mixture further comprises peppermint oil, lemon oil, citronella oil, rosemary oil, clove oil and geranium oil.

32. The covering as claimed in claim 27, wherein said all natural insect and animal repellent mixture further comprises 15% peppermint oil, 10% lemon oil, 4% citronella oil, 5% rosemary oil, 3% clove oil and 3% geranium oil.

33. The covering as claimed in claim 28, wherein said all natural insect and animal repellent mixture further comprises peppermint oil, lemon oil, citronella oil, rosemary oil, clove oil and geranium oil.

34. The covering as claimed in claim 28, wherein said all natural insect and animal repellent mixture further comprises 15% peppermint oil, 10% lemon oil, 4% citronella oil, 5% rosemary oil, 3% clove oil and 3% geranium oil.
